(19) United States
(12) Patent Application Publication
(10) Pub. No.: US 2020/0026875 A1
(43) Pub. Date: Jan. 23, 2020

(54) PROTECTED HEALTH INFORMATION IN DISTRIBUTED COMPUTING SYSTEMS

(71) Applicant: Nutanix, Inc., San Jose, CA (US)

(72) Inventors: Andre LEIBOVICI, Mountain View, CA (US); Daniel P. COWAN, Kansas City, MO (US)

(73) Assignee: Nutanix, Inc., San Jose, CA (US)

(21) Appl. No.: 15/431,190

(22) Filed: Feb. 13, 2017

(51) Int. Cl. G06F 21/62

(52) U.S. Cl. CPC G06F 21/6245; G06F 19/322

(57) ABSTRACT

A method commences upon receiving a first one of a series of commands corresponding to various operations (e.g., in a test or development setting) that are intended to access protected health information (PHI). Initially, the protected health information is stored in a protected source datastore that is logically represented by source metadata. Rather than copy PHI, the method clones the metadata, leaving the PHI uncopied and unmodified. Execution of a read-only operation over the protected health information is performed by referencing the cloned metadata to access the protected health information. In the event of an occurrence of an operation (e.g., a testing operation), a temporary, ephemeral datastore is formed. Responsive to received write operations pertaining to the protected health information, the data pertaining to the intended write operations are pre-staged into the ephemeral datastore. After use, ephemeral data is overwritten, purged from caches, and then the ephemeral datastore is deleted.

### FIELD

This disclosure relates to computing platform management, and more particularly to techniques for managing metadata pertaining to protected health information stored in distributed computing systems.

### BACKGROUND

Electronic medical record (EMR) or electronic health record (EHR) systems and applications host and/or access sensitive patient data classified as protected health information (PHI). PHI is any information about health status, provision of health care, or payment for health care that is created or collected by a “covered entity” (e.g., health care provider, health plan, public health authority, employer, life insurer, school or university, etc.) that can be linked to a specific individual. Such covered entities are required to maintain compliance with various privacy laws and regulations such as the Health Insurance Portability and Accountability Act (HIPAA) established in 1996, when managing (e.g., storing, accessing, distributing, etc.) PHI. Procedures and practices for handling of existing and newly created PHI is audited regularly to maintain such compliance. For example, storage of and access to existing PHI pertaining to a given EMR application or applications is audited for compliance. PHI accessed and/or created for ephemeral tasks is also to be compliant. For example, PHI associated with EMR application testing, development and/or training must be compliant with any applicable regulations.

Many modern EMR applications are implemented in hyperconverged distributed computing systems to take advantage of the efficient and cost-effective scaling of distributed computing resources, distributed data storage resources, distributed networking resources, and/or other resources facilitated by such hyperconverged systems. Hyperconverged distributed computing systems have evolved in such a way that incremental linear scaling can be accomplished in many dimensions.

The resources in a given distributed system are often grouped into resource subsystems such as clusters, datacenters, or sites. The resource subsystems can be defined by logical and/or physical boundaries. For example, a cluster might comprise a logically bounded set of nodes associated with a department of an enterprise, while a datacenter might be associated with a particular physical geographical location. Modern clusters in hyperconverged distributed computing systems might support over one hundred nodes (or more) that in turn support as many as several thousands (or more) autonomous virtualized entities (VEs). The VEs in hyperconverged distributed computing systems might be virtual machines (VMs) and/or executable containers, in hypervisor-assisted virtualization environments and/or in operating system virtualization environments, respectively. The clusters further comprise multiple tiers of storage in a storage pool for storing various data and metadata, such as data and metadata pertaining to PHI.

Unfortunately, legacy approaches might create a duplicate copy and/or propagate access through logical unit numbers (LUNs) of a certain set of PHI associated with a particular EMR application to facilitate development or testing of a new version of the application. In this case, the copy and/or the data accessed through the propagated LUN also contains PHI and is subject to compliance with any applicable law or regulation, which might include restrictions as to the physical and/or logical storage location of the copy. For example, such PHI might be restricted to storage facilities or portions of storage facilities (e.g., datastores) deemed HIPAA compliant. Removal of the PHI copy when testing is completed can further be subject to certain mandatory procedures to maintain compliance. Practices of these legacy approaches introduce compliance violation risks that might negatively impact the reputation and/or continued operations of the healthcare providers and/or the IT systems providers. Protection of PHI in compliance with rules and regulations demands technological solutions for managing PHI under a wide range of settings, including in various development and/or testing settings.

What is needed is a technique or techniques to improve over legacy techniques and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for protected health information in distributed computing systems, which techniques advance the relevant technologies to address technological issues with legacy approaches. More specifically, the present disclosure provides a detailed description of techniques used in systems, methods, and in computer program products for protected health information in distributed computing systems. Certain embodiments are directed to technological solutions for generating an ephemeral datastore and a clone of the metadata associated with a protected health information (PHI) source datastore to facilitate performance of tasks pertaining to the PHI.

The disclosed embodiments modify and improve over legacy approaches. In particular, the herein-disclosed techniques provide technical solutions that address the technical problems attendant to maintaining regulatory compliance of protected health information accessed for specialized tasks (e.g., training tasks, development tasks, etc.) in a hyperconverged distributed computing system. Various applications of the herein-disclosed improvements in computer functionality serve to reduce the demand for computer memory, reduce the demand for computer processing power, reduce network bandwidth use, and reduce the demand for inter-component communication, all while still protecting patient health information.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1 presents a protected healthcare information management technique as implemented in a distributed system, according to an embodiment.

FIG. 2A illustrates a working environment that supports various metadata and datastore management techniques as used when operating over protected health information in distributed computing systems, according to an embodiment.

FIG. 2B presents a storage facility generation technique as implemented in systems that protect health information, according to an embodiment.

FIG. 3A depicts a protection domain environment as implemented in hyperconverged distributed computing systems that store and manage protected health information, according to an embodiment.

FIG. 3B presents an operational environment selection technique as implemented in systems that protect health information, according to an embodiment.

FIG. 3C presents an information access management technique as implemented in systems that protect health information, according to an embodiment.

FIG. 4 presents a hyperconverged distributed computing environment in which embodiments of the present disclosure can operate, according to an embodiment.

FIG. 5 depicts system components as arrangements of computing modules that are interconnected so as to implement certain of the herein-disclosed embodiments.

FIG. 6A and FIG. 6B depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of maintaining regulatory compliance of protected health information accessed for training and development tasks in a distributed computing system. Some embodiments are directed to approaches for generating an ephemeral datastore and a clone of the metadata associated with a protected health information (PHI) source datastore to facilitate performance of tasks pertaining to the PHI without modifying or propagating the PHI. Further, the accompanying figures and discussions herein present example environments, systems, methods, and computer program products for protected health information in hyperconverged distributed computing systems.

### Overview

Disclosed herein are techniques for generating an ephemeral datastore and a clone of metadata associated with a protected health information (PHI) source datastore. The ephemeral datastore and cloned metadata can both be maintained ephemerally, for use only during execution of ephemeral tasks, such as application development or testing, pertaining to the PHI. The ephemeral datastore and cloned metadata can be operated over during such tasks without modifying or propagating the PHI. In certain embodiments, instructions are received that request access to the PHI source datastore for performing various ephemeral tasks such as EMR application testing, development, or training. The clone of the metadata associated with the PHI source datastore is generated to provide read-only access to the PHI source datastore. The ephemeral datastore is created to facilitate read-write operations pertaining to the ephemeral task. When the ephemeral task or tasks are completed, the cloned metadata and the ephemeral datastore are deleted. In certain embodiments, the storage location of the cloned metadata and/or the ephemeral datastore is determined based on a set of protection domain rules. In some embodiments, snapshotting techniques are used to generate the cloned metadata for accessing the PHI source datastore and/or the ephemeral datastore. In some embodiments, a protection domain can comprise PHI source datastores, nodes, hard disk drives, solid state disk drives, virtual machines, virtual disks, and/or EMR applications.

Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

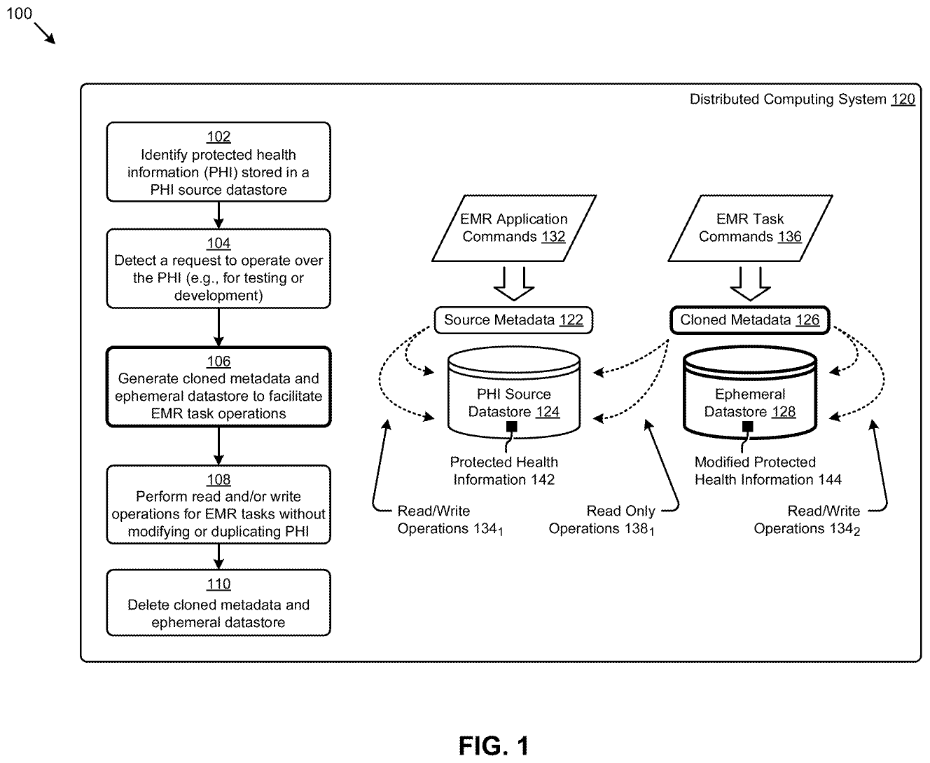

FIG. 1 presents a protected healthcare information management technique 100 as implemented in a distributed system. As an option, one or more variations of protected healthcare information management technique 100 or any aspect thereof may be implemented in the context of the architecture and functionality of the embodiments described herein. The protected healthcare information management technique 100 or any aspect thereof may be implemented in any environment.

The protected healthcare information management technique 100 presents one embodiment of steps and/or operations executed according to the herein disclosed techniques to manage protected health information in a distributed computing system 120. Specifically, the protected healthcare information management technique 100 might commence with identifying a set of protected health information (PHI) such as protected health information 142 in a PHI source datastore 124 (step 102). PHI is any information about health status, provision of health care, or payment for health care that is created or collected by a “covered entity” (e.g., health care provider, health plan, public health authority, employer, life insurer, school or university, etc.) that can be linked to a specific individual.

PHI is often organized and/or stored in a tabular structure (e.g., relational database table) having rows corresponding to a unique identifier of a particular individual, and columns corresponding to information associated with that individual. Various collections of PHI can be referred to as electronic medical records (EMRs). The datastores (e.g., PHI source datastore 124) for storing PHI are logical or physical portions (e.g., segments, volumes, disks, virtual disks, containers, etc.) of one or more storage facilities allocated for storing the PHI. For example, a datastore might comprise a 1 TB storage segment of a 100 TB storage volume or storage pool.

As can be observed in FIG. 1, a set of source metadata 122 can facilitate access to the protected health information 142 at the PHI source datastore 124 by various instances of commands from an electronic medical record (EMR) application (e.g., EMR application commands 132). An EMR application is a software application that manipulates or manages EMRs. The metadata, such as source metadata 122, as described herein comprise information characterizing virtual or logical representations of physically stored data to facilitate efficient access and data management operations. For example, EMR application commands 132 can reference a virtual disk specified in source metadata 122 that points to physical data blocks comprising the protected health information 142 in the PHI source datastore 124. As shown, read and/or write operations (e.g., read/write operations 134₁) can be performed over the PHI source datastore 124 by the EMR application.

The EMR tasks as discussed herein are sets of operations that rely on access to at least some portion of PHI. For example, an EMR task might comprise instantiating a certain EMR application for the purposes of testing or developing the application. Specifically, examples of an EMR task can comprise an application development task, an application testing task, an application training task, and/or another task. In any case, the EMR task might be required to be executed without modifying, duplicating, or propagating the corresponding PHI so as to comply with various PHI regulations (e.g., HIPAA).

The herein disclosed techniques can address such restrictions by detecting any EMR task commands (e.g., EMR task commands 136) issued to operate over the protected health information 142 (step 104). A set of cloned metadata 126 (e.g., cloned from source metadata 122) and an ephemeral datastore 128 are generated to facilitate certain EMR task operations (step 106). The cloned metadata 126 and the ephemeral datastore 128 can be used to perform read and write operations associated with the EMR tasks, yet without modifying the protected health information 142 in the PHI source datastore 124 (step 108). Specifically, the cloned metadata 126 can point to the PHI source datastore 124 for read-only operations 138₁, and can point to the ephemeral datastore 128 for modifying operations (e.g., read/write operations 134₂). The ephemeral datastore 128 will hold any modified protected health information 144 produced as a result of an EMR task, while the PHI source datastore 124 remains unaffected by the execution of the EMR tasks. When an EMR task is complete, the cloned metadata 126 and the ephemeral datastore 128 can be deleted (step 110).

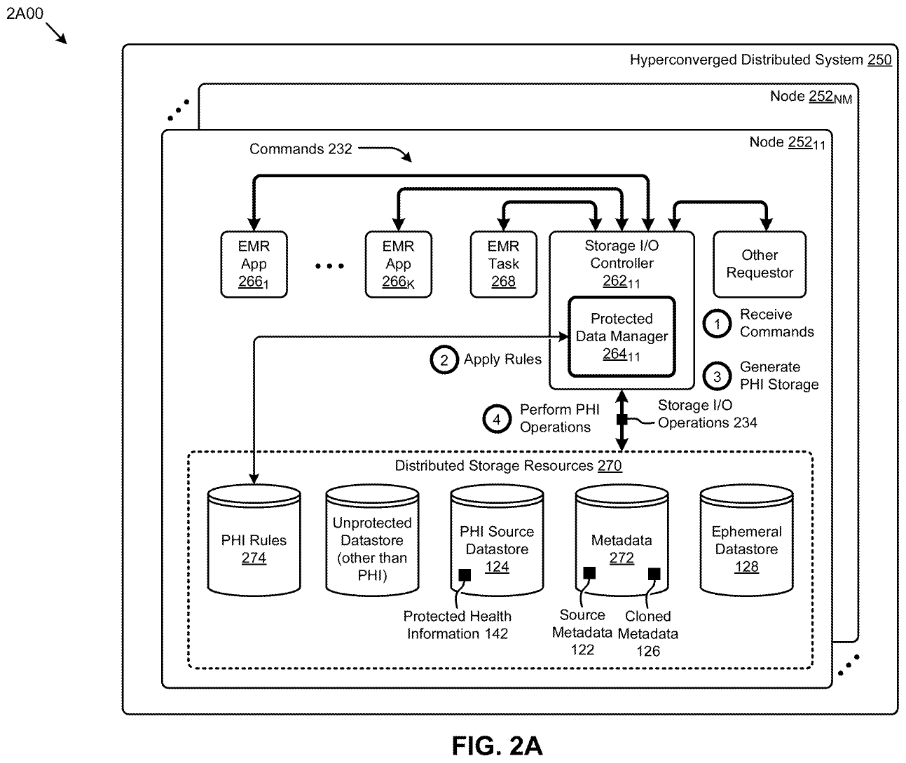

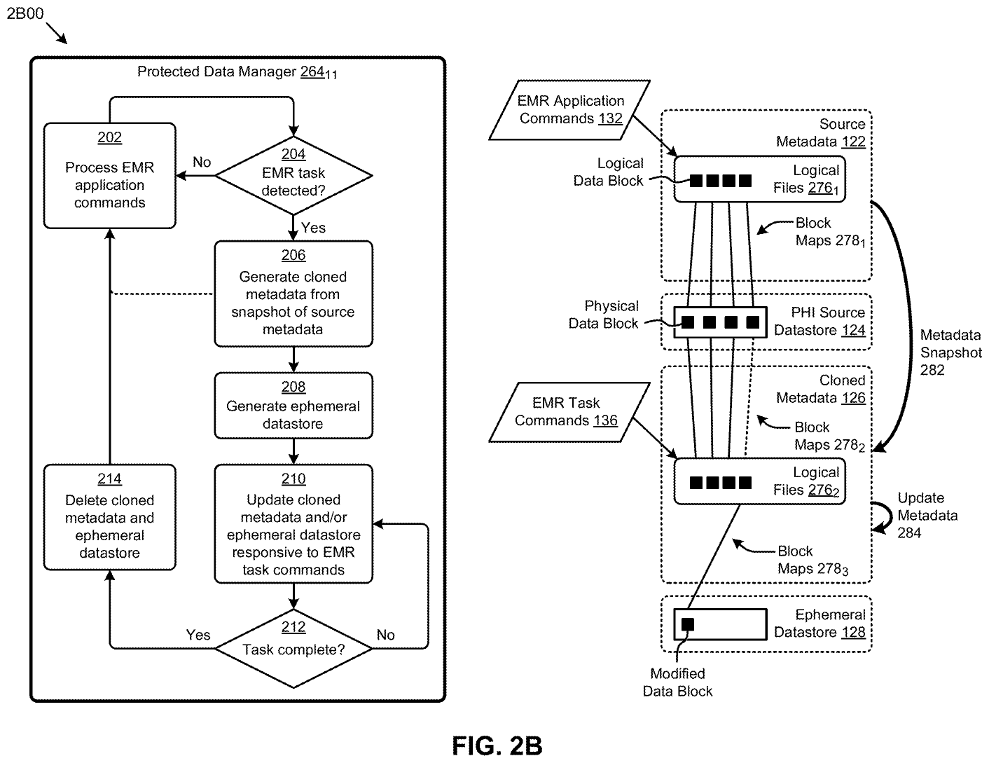

One embodiment of a subsystem and corresponding data flows for implementing any of the herein disclosed techniques is shown and described as pertaining to FIG. 2A.

FIG. 2A illustrates a working environment 2A00 that supports various metadata and datastore management techniques as used when operating over protected health information in distributed computing systems. As an option, one or more variations of working environment 2A00 or any aspect thereof may be implemented in the context of the architecture and functionality of the embodiments described herein.

The embodiment shown in FIG. 2A illustrates an instance of a protected data manager 264₁₁ implemented in a hyperconverged distributed system 250 managing protected health information in the system. Specifically, protected data manager 264₁₁ is shown to be implemented in an instance of a storage input and output (I/O or IO) controller (e.g., storage I/O controller 262₁₁) operating at a representative node (e.g., node 252₁₁) in hyperconverged distributed system 250.

Other instances of the protected data manager and/or the storage I/O controller at other nodes (e.g., node 252_{NM}) in hyperconverged distributed system 250 are possible. Various applications (e.g., EMR app 266₁, . . . , EMR app 266_{K}) and/or tasks (e.g., EMR task 268) interact with storage I/O controller 262₁₁ and protected data manager 264₁₁ to access various data (e.g., PHI) stored in a set of distributed storage resources 270 in the hyperconverged distributed system 250. Specifically, the applications and/or tasks can issue various instances of commands 232 that are transformed into a corresponding set of storage I/O operations 234 by the storage I/O controller 262₁₁ and/or the protected data manager 264₁₁. The storage I/O operations 234 are used to access the PHI source datastore 124 or the ephemeral datastore 128 using metadata 272 (e.g., source metadata 122, cloned metadata 126, etc.) earlier described. The foregoing datastores, metadata, and a set of PHI rules 274 can be stored locally at node 252₁₁ and/or distributed across multiple nodes in the distributed storage resources 270.

The protected health information rules (e.g., PHI rules 274) comprise various constraints that are applied to certain aspects pertaining to managing protected health information. For example, PHI rules 274 might comprise constraints as to the location (e.g., node, storage facility, virtualized entity, etc.) used to operate an EMR application (e.g., EMR app 266₁) and/or constraints pertaining to an EMR task (e.g., EMR task 268), and/or constraints as to the locations used to allocate storage for storing PHI (e.g., PHI source datastore 124, ephemeral datastore 128, etc.) and/or constraints pertaining to the PHI-related or PHI-derived information (e.g., source metadata 122, cloned metadata 126, etc.). Such location or domain constraints are often organized and/or stored in a tabular structure (e.g., a relational database table). PHI rules 274 might further comprise constraints in the form of conditional logic to facilitate other aspects pertaining to managing protected health information. For example, conditional logic might be applied to commands 232 to determine the metadata and/or datastores to access in the distributed storage resources 270.

As further shown, the working environment 2A00 shown in FIG. 2A can facilitate the herein disclosed techniques at least in part by receiving commands (e.g., commands 232) from EMR applications and/or EMR tasks at the protected data manager 264₁₁ (step 1). The PHI rules 274 can be applied to the commands (step 2) to generate any PHI storage to facilitate execution of the commands (step 3). For example, an initiating command or other commands from EMR task 268 can be detected so as to invoke the generation of cloned metadata 126 and/or the generation of the ephemeral datastore 128. Protected data manager 264₁₁ and/or other functions provided by the storage I/O controller 262₁₁ can then facilitate performance of various PHI-related operations associated with the EMR applications and/or EMR tasks (step 4). Specifically, in accordance with the herein disclosed techniques, commands associated with the EMR tasks can be executed without modifying or propagating the protected health information 142 at the PHI source datastore.

The components and data flows shown in FIG. 2A present merely one partitioning and associated data manipulation approach. The specific example shown is purely exemplary, and other subsystems and/or partitioning are reasonable. One embodiment of a technique for generating the cloned metadata 126 and ephemeral datastore 128 in such systems, subsystems, and/or partitionings is shown and described as pertaining to FIG. 2B.

FIG. 2B presents a storage facility generation technique 2B00 as implemented in systems that protect health information. As an option, one or more variations of storage facility generation technique 2B00 or any aspect thereof may be implemented in the context of the architecture and functionality of the embodiments described herein. The storage facility generation technique 2B00 or any aspect thereof may be implemented in any environment.

The storage facility generation technique 2B00 depicts one embodiment of the steps and/or operations implemented at the protected data manager 264₁₁ for generating the cloned metadata 126 and ephemeral datastore 128 according to the herein disclosed techniques. As can be observed, the storage facility generation technique 2B00 can continually process (see “No” path of decision 204) EMR application commands (step 202) until an EMR task is detected (decision 204). For example, and as shown, EMR application commands 132 can reference the source metadata 122 to access the PHI source datastore 124. The source metadata 122 holds virtual or logical representations of the physical data at the PHI source datastore 124 in a set of logical files 276₁ (e.g., virtual disks or vDisks, etc.). A set of block maps 278₁ can also be stored in source metadata 122 to map the logical data blocks of the logical files 276₁ to their corresponding instances of physical data blocks in the PHI source datastore 124.

Responsive to detecting an EMR task (see “Yes” path of decision 204), a set of cloned metadata 126 can be generated from a snapshot of the source metadata 122 (step 206). Specifically, a metadata snapshot 282 can be executed to replicate the then-current logical files and block maps of the source metadata 122 to create an instance of the cloned metadata 126. No PHI is included in the cloned metadata 126. Further, no data (e.g., PHI) from the PHI source datastore 124 is duplicated or propagated.

As shown in FIG. 2B, the protected data manager 264₁₁ can continue to process EMR application commands (step 202) while performing other steps and/or operations associated with the storage facility generation technique 2B00, such as generating the ephemeral datastore 128 (step 208) and/or other operations. In certain embodiments, the ephemeral datastore 128 initially comprises no data blocks. As further EMR task commands 136 are processed, the cloned metadata 126 and/or the ephemeral datastore 128 are updated responsive to the EMR task commands (step 210). For example, the logical files 276₂ of the cloned metadata 126 map to the data blocks in the PHI source datastore 124 when the cloned metadata 126 is first instantiated. Any modified data blocks introduced by the EMR task commands are written to the ephemeral datastore 128, and the block maps (e.g., block maps 278₂ and block maps 278₃) of the cloned metadata 126 are updated (operation 284) to point to the unmodified data blocks in the PHI source datastore 124 and the modified data blocks in the ephemeral datastore 128. While the EMR task processing continues (see “No” path of decision 212), the foregoing cloned metadata and ephemeral datastore updates also continue (step 210). When an EMR task is complete (see “Yes” path of decision 212), the cloned metadata 126 and the ephemeral datastore 128 can be deleted (step 214). Traces of any of the PHI that were present in the ephemeral datastore 128 can be cleaned (e.g., overwritten with ‘0’ data). In some cases, deep cleaning is performed by reading the ‘0’ data so as to bring the ‘0’ data into any cache or caches that might be in operation.

In some embodiments, generating the cloned metadata and/or ephemeral datastore can be scheduled according to various resource usage metrics collected from the hyperconverged distributed system. For example, performance metrics for compute resources, storage resources, network resources, and/or other resources can be analyzed to determine a time and/or location (e.g., node, virtualized entity, hard disk drive, etc.) for invoking EMR tasks, executing EMR commands, generating cloned metadata (e.g., snapshotting), generating ephemeral datastores, and/or performing other operations.

Further details regarding general approaches to resource scheduling in hyperconverged distributed computing system are described in U.S. application Ser. No. 15/341,549 titled, “LONG-RANGE DISTRIBUTED RESOURCE PLANNING USING WORKLOAD MODELING IN HYPERCONVERGED COMPUTING CLUSTERS” filed on Nov. 2, 2016, which is hereby incorporated by reference in its entirety.

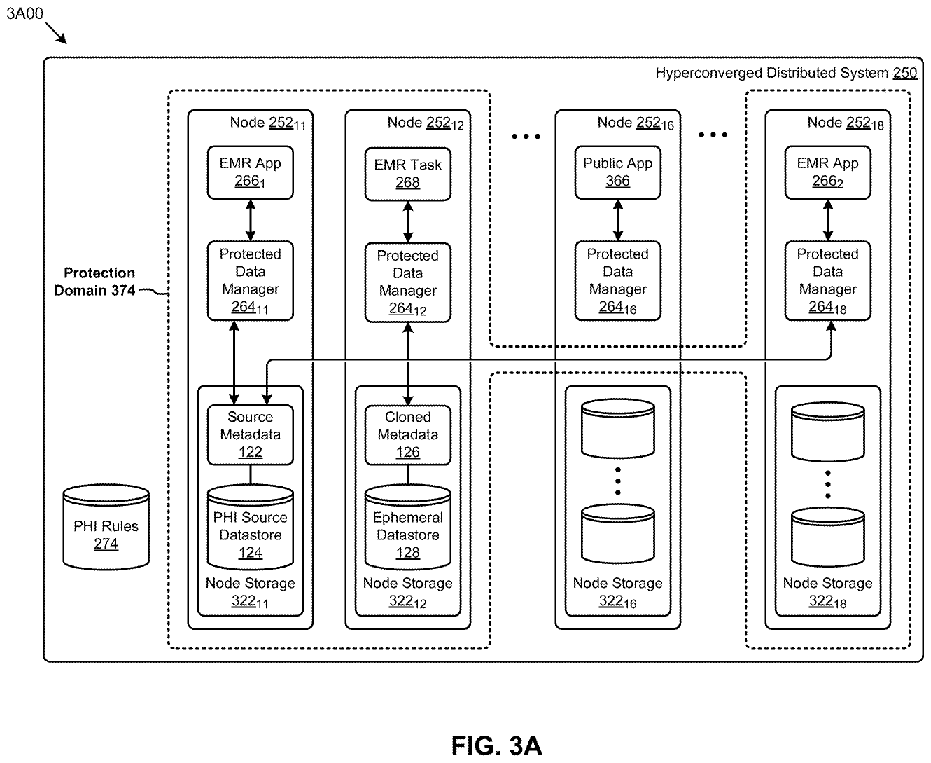

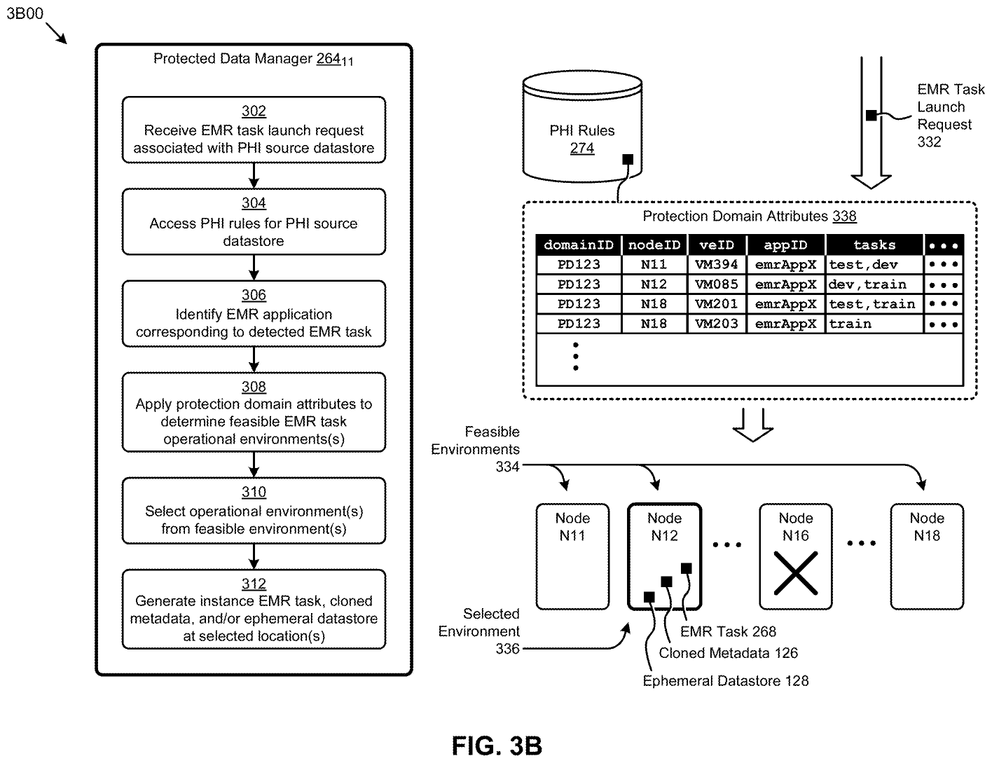

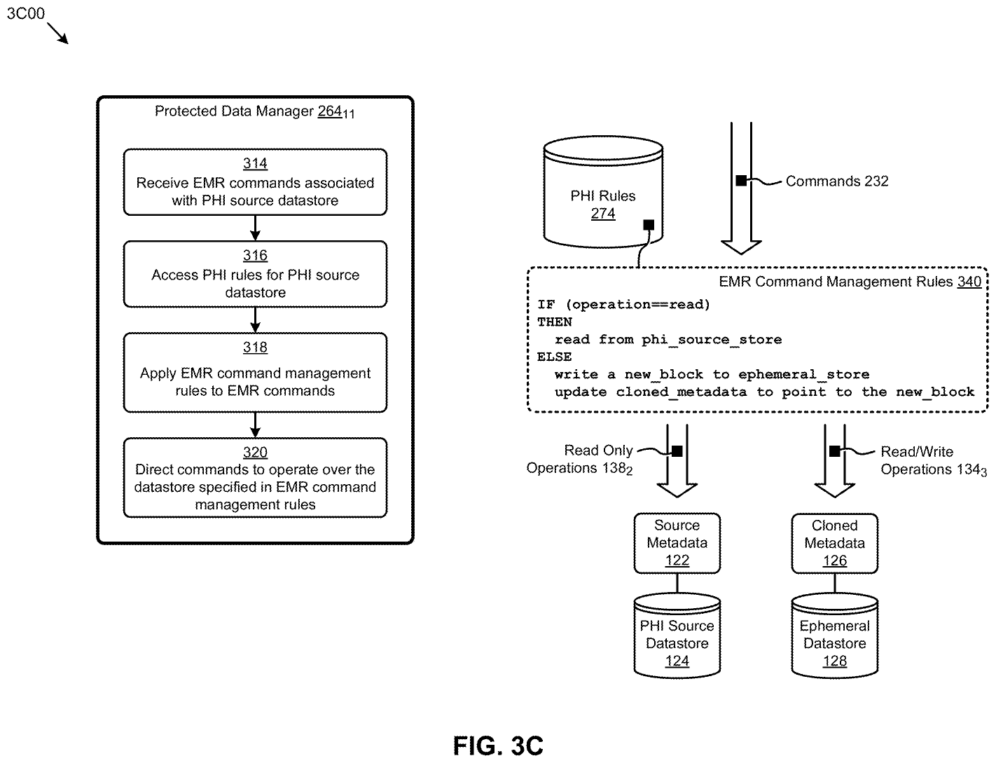

In some cases, the resources in a hyperconverged distributed system that serve protected health information is limited. Such a collection of resources can be referred to as a protection domain. Protection domains are a set of logically and/or physically bounded resources associated with a respective set or sets of PHI. The resources comprising a protection domains can include one or more nodes, one or more virtualized entities (e.g., VMs, containers, etc.), one or more datastores, one or more applications (e.g., EMR applications, EMR tasks, etc.), and/or other types of resources. An example of a protection domain in a hyperconverged distributed computing environment is shown and described as pertaining to FIG. 3A.

FIG. 3A depicts a protection domain environment 3A00 as implemented in hyperconverged distributed computing systems that store and manage protected health information. As an option, one or more variations of protection domain environment 3A00 or any aspect thereof may be implemented in the context of the architecture and functionality of the embodiments described herein.

The embodiment shown in FIG. 3A is merely one example of a protection domain (e.g., protection domain 374) in the hyperconverged distributed system 250. A representative set of nodes (e.g., node 252₁₁, node 252₁₂, . . . , node 252₁₆, . . . , and node 252₁₈) from hyperconverged distributed system 250 are shown. Each node comprises a respective set of storage resources (e.g., node storage 322₁₁, node storage 322₁₂, . . . , node storage 322₁₆, . . . , and node storage 322₁₈). Each node further comprises various compute resources, networking resources, and/or other resources. An instance of the protected data manager (e.g., protected data manager 264₁₁, protected data manager 264₁₂, . . . , protected data manager 264₁₆, . . . , and protected data manager 264₁₈) is implemented at each node. As can be observed, a portion of the representative resources shown from hyperconverged distributed system 250 comprise the protection domain 374. Specifically, the resources associated with node 252₁₁, node 252₁₂, and node 252₁₈ are included in protection domain 374. Other nodes (e.g., node 252₁₆) and resources from hyperconverged distributed system 250 are not included in the protection domain 374.

In certain embodiments, the resources associated with protection domain 374 can be identified and/or otherwise described in a set of PHI rules 274. Multiple protection domains comprising the resources from the hyperconverged distributed system 250 can be characterized in the PHI rules 274. As earlier described, a protection domain is often associated with a respective set of PHI. In the example shown in FIG. 3A, protection domain 374 is associated with the PHI stored in PHI source datastore 124 at node 252₁₁. As such, related data (e.g., source metadata 122, cloned metadata 126, ephemeral datastore 128, etc.), related applications and tasks (e.g., EMR app 266₁, EMR app 2662, EMR task 268, etc.), and/or other resources related to the PHI associated with protection domain 374 are permitted in protection domain 374. In contrast, resources not included in protection domain 374 are not permitted to serve any function or operation related to the PHI associated with the protection domain 374. For example, node 252₁₆ is not permitted to provide compute, storage, network, and/or other resources related to the PHI associated with protection domain 374. In this case, node 252₁₆ might serve provide other applications (e.g., public app 366) to the users of the hyperconverged distributed system 250.

The aforementioned PHI rules 274 can be applied to various operations facilitated by the herein disclosed techniques. Examples of applying the PHI rules 274 are shown and described as pertaining to FIG. 3B and FIG. 3C.

FIG. 3B presents an operational environment selection technique 3B00 as implemented in systems that protect health information. As an option, one or more variations of operational environment selection technique 3B00 or any aspect thereof may be implemented in the context of the architecture and functionality of the embodiments described herein. The operational environment selection technique 3B00 or any aspect thereof may be implemented in any environment.

The embodiment shown in FIG. 3B is merely one example of applying protection domain rules to facilitate selecting an operational environment for various aspects of the herein disclosed techniques. Specifically, the operational environment selection technique 3B00 facilitated by the protected data manager 264₁₁ can commence with receiving an EMR task launch request 332 associated with a certain PHI source datastore (step 302). The EMR task launch request 332 might be received at the protected data manager 264₁₁ in an EMR task command. A set of PHI rules (e.g., PHI rules 274) associated with the PHI source datastore is accessed (step 304). The PHI rules 274, for example, might comprise data describing various protection domains. In certain embodiments, the protection domain data might be organized as shown in the protection domain attributes 338. As can be observed, the protection domain attributes 338 are organized in a database table having columns associated with a protection domain identifier or “domainID”, a node identifier or “node ID”, a virtualized entity identifier or “veID”, an application identifier or “appID”, a list of associated “tasks”, and/or other attributes corresponding to a given protection domain identified by “domainID”.

The EMR application associated with an EMR task to be launched can be identified by or associated with protection domain attributes 338 (step 306). For example, an EMR task might be a “test” task associated with EMR application “emrAppX”. The protection domain attributes 338 are further applied to determine a set of feasible EMR task operational environments (step 308). For example, the protection domain attributes 338 indicate the application “emrAppX” corresponds to protection domain “PD123” which, in turn, comprises node “N11”, node “N12”, and node “N18” (but not node “N16”). As illustrated in FIG. 3B, the foregoing nodes comprise a set of feasible environments 334. Portions of a node, multiple nodes, and/or another set of resources can comprise the feasible environments. The operational environment selection technique 3B00 then selects one or more operational environments from the feasible environments 334 (step 310). For example, node “N12” might be the selected environment 336. Portions of a node, multiple nodes, and/or another set of resources can comprise the selected environment. The selected environment or environments might be selected based on resource availability, resource cost, and/or other resource attributes. The various resources at the selected environment 336 are then configured to facilitate various components (e.g., EMR task 268, cloned metadata 126, ephemeral datastore 128, etc.) implemented according to the herein disclosed techniques (step 312).

FIG. 3C presents an information access management technique 3C00 as implemented in systems that protect health information. As an option, one or more variations of information access management technique 3C00 or any aspect thereof may be implemented in the context of the architecture and functionality of the embodiments described herein. The information access management technique 3C00 or any aspect thereof may be implemented in any environment.

The embodiment shown in FIG. 3C is merely one example of applying command management rules to facilitate directing commands that access protected health information as pertaining to the herein disclosed techniques. Specifically, the information access management technique 3C00 facilitated by the protected data manager 264₁₁ can commence with receiving EMR application or task commands (e.g., commands 232) associated with a certain PHI source datastore (step 314). A set of PHI rules (e.g., PHI rules 274) associated with at least the aforementioned PHI source datastore is accessed (step 316). The PHI rules 274, for example, might comprise data (e.g., programming code) that can be interpreted as conditional logic to determine certain aspects related to processing the commands 232. Example pseudo-code representing such conditional logic is shown in a set of EMR command management rules 340.

The EMR command management rules 340 are applied to commands 232 (step 318) to direct the commands 232 to operate over the source metadata 122 and PHI source datastore 124 using a set of read-only operations 1382, or operate over the cloned metadata 126 and ephemeral datastore 128 using a set of read/write operations 1343 (step 320). For example, as shown in the EMR command management rules 340, if a received instance of the commands 232 comprises an “operation” that is a “read” (e.g., read-only) operation, then the operation will “read” from PHI source datastore 124 (e.g., “phi_source_store”). As further shown, if the “operation” is not a “read” operation, the EMR command management rules 340 will direct the operation to “write” a new block (e.g., “new_block”) to the ephemeral datastore 128 (e.g., “ephemeral_store”) and “update” the cloned metadata 126 (e.g., “cloned_metadata”) to point to the “new block”. As can be appreciated, computing resources are conserved using this technique, at least in that for the aforementioned class of read-only operations, only metadata is cloned; the PHI itself is not cloned.

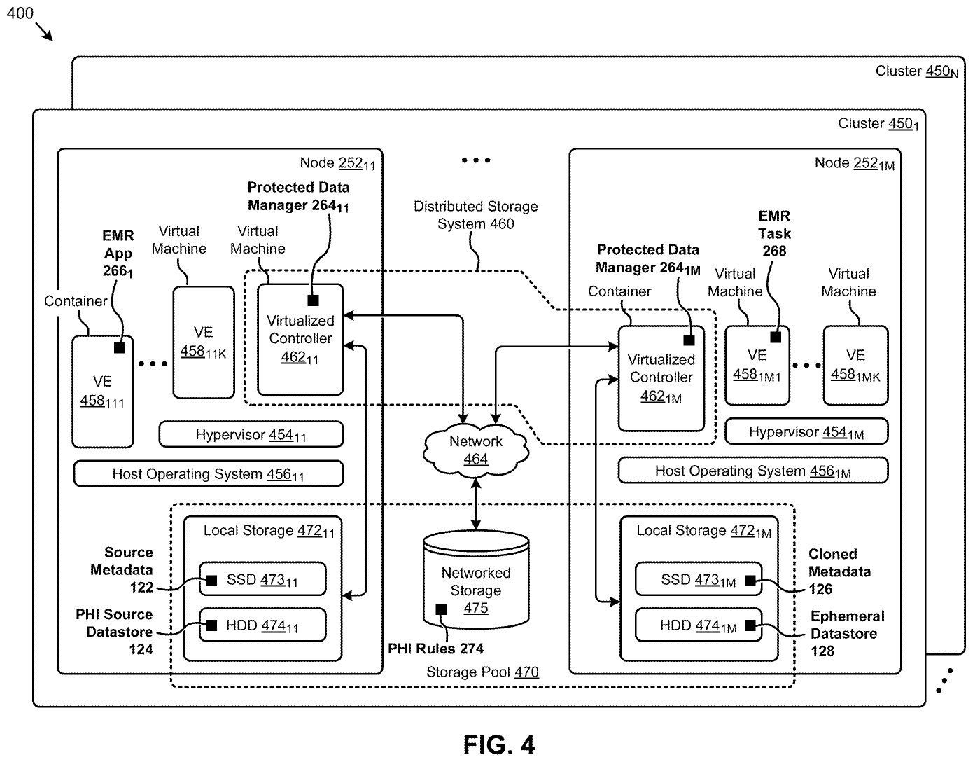

One embodiment of an environment for implementing any of the herein disclosed techniques is shown and described as pertaining to FIG. 4.

FIG. 4 presents a hyperconverged distributed computing environment 400 in which embodiments of the present disclosure can operate. As an option, one or more variations of hyperconverged distributed computing environment 400 or any aspect thereof may be implemented in the context of the architecture and functionality of the embodiments described herein.

The shown hyperconverged distributed computing environment depicts various components associated with one instance of a distributed virtualization system comprising a distributed storage system 460 that can be used to implement the herein disclosed techniques. Specifically, the hyperconverged distributed computing environment 400 comprises multiple clusters (e.g., cluster 450₁, . . . , cluster 450_{N}) comprising multiple nodes that have multiple tiers of storage in a storage pool. Representative nodes (e.g., node 252₁₁, . . . , node 252_{1M}) and storage pool 470 associated with cluster 450₁ are shown. Each node can be associated with one server, multiple servers, or portions of a server. The nodes can be associated (e.g., logically and/or physically) with the clusters. As shown, the multiple tiers of storage include storage that is accessible through a network 464, such as a networked storage 475 (e.g., a storage area network or SAN, network attached storage or NAS, etc.). The multiple tiers of storage further include instances of local storage (e.g., local storage 472₁₁, . . . , local storage 472_{1M}). For example, the local storage can be within or directly attached to a server and/or appliance associated with the nodes. Such local storage can include solid state drives (SSD 473₁₁, . . . , SSD 473_{1M}), hard disk drives (HDD 474₁₁, . . . , HDD 474_{1M}), and/or other storage devices.

As shown, the nodes in hyperconverged distributed computing environment 400 can implement one or more user virtualized entities (e.g., VE 458₁₁₁, . . . , VE 458_{11K}, . . . , VE 458_{1M1}, . . . , VE 458_{1MK}) such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 456₁₁, . . . , host operating system 456_{1M}), while the VMs run multiple applications on various respective guest operating systems. Such flexibility can be facilitated at least in part by a hypervisor (e.g., hypervisor 454₁₁, . . . , hypervisor 454_{1M}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 456₁₁, . . . , host operating system 456_{1M}) with, in most cases, no hypervisor layer. This lightweight implementation can facilitate efficient distribution of certain software components such as applications or services (e.g., micro-services). As shown, hyperconverged distributed computing environment 400 can implement both a hypervisor-assisted virtualization environment and a container virtualization environment for various purposes.

Hyperconverged distributed computing environment 400 also comprises at least one instance of a virtualized controller to facilitate access to storage pool 470 by the VMs and/or containers.

As used in these embodiments, a virtualized controller is a collection of software instructions that serve to abstract details of underlying hardware or software components from one or more higher-level processing entities. A virtualized controller can be implemented as a virtual machine as a container (e.g., a Docker container), or within a layer (e.g., such as a hypervisor).

Multiple instances of such virtualized controllers can coordinate within a cluster to form the distributed storage system 460 which can, among other operations, manage the storage pool 470. This architecture further facilitates efficient scaling of the distributed virtualization system. The foregoing virtualized controllers can be implemented in hyperconverged distributed computing environment 400 using various techniques. Specifically, an instance of a virtual machine at a given node can be used as a virtualized controller in a hypervisor-assisted virtualization environment to manage storage and I/O activities. In this case, for example, the virtualize entities at node 252₁₁ can interface with a controller virtual machine (e.g., virtualized controller 462₁₁) through hypervisor 454₁₁ to access the storage pool 470. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 460.

For example, a hypervisor at one node in the distributed storage system 460 might correspond to VMware ESXi software, and a hypervisor at another node in the distributed storage system 460 might correspond to Nutanix AHV software. As another virtualized controller implementation example, containers (e.g., Docker containers) can be used to implement a virtualized controller (e.g., virtualized controller 462_{1M}) in an operating system virtualization environment at a given node. In this case, for example, the virtualized entities at node 252_{1M} can access the storage pool 470 by interfacing with a controller container (e.g., virtualized controller 462_{1M}) through hypervisor 454_{1M} and/or the kernel of host operating system 456_{1M}.

In certain embodiments, one or more instances of a protected data manager can be implemented in distributed storage system 460 to facilitate the herein disclosed techniques. Specifically, protected data manager 264₁₁ can be implemented in virtualized controller 462₁₁, and protected data manager 264_{1M} can be implemented in virtualized controller 462_{1M}. Such instances of the protected data manager and/or the virtualized controller can be implemented in any node in any cluster. Actions taken by one or more instances of the protected data manager and/or virtualized controller can apply to a node (or between nodes) and/or to a cluster (or between clusters) and/or between any resources or subsystems accessible by the virtualized controller or their agents (e.g., protected data manager).

As further shown, any of the foregoing virtualized entities can host the earlier described EMR applications and/or EMR tasks. For example, EMR app 266₁ might run on VE 458₁₁ᵢ and EMR task 268 might run on VE 458_{1M1}. As can be observed, the metadata and datastores associated with the herein disclosed techniques can be stored in various storage facilities in the storage pool 470. As an example, source metadata 122 might be stored at SSD 473₁₁, PHI source datastore 124 might be stored at HDD 474₁₁, cloned metadata 126 might be stored at SSD 473_{1M}, and ephemeral datastore 128 might be stored in non-persistent volatile memory or at HDD 474_{1M}. The particular resources in the hyperconverged distributed computing environment 400 selected to host the EMR applications, EMR tasks, metadata, datastores, and/or other resource consumers related to the herein disclosed techniques might be determined based on the PHI rules 274 (e.g., protection domain attributes, EMR command management rules, etc.) stored in the networked storage 475.

### ADDITIONAL EMBODIMENTS OF THE DISCLOSURE

### Additional Practical Application Examples

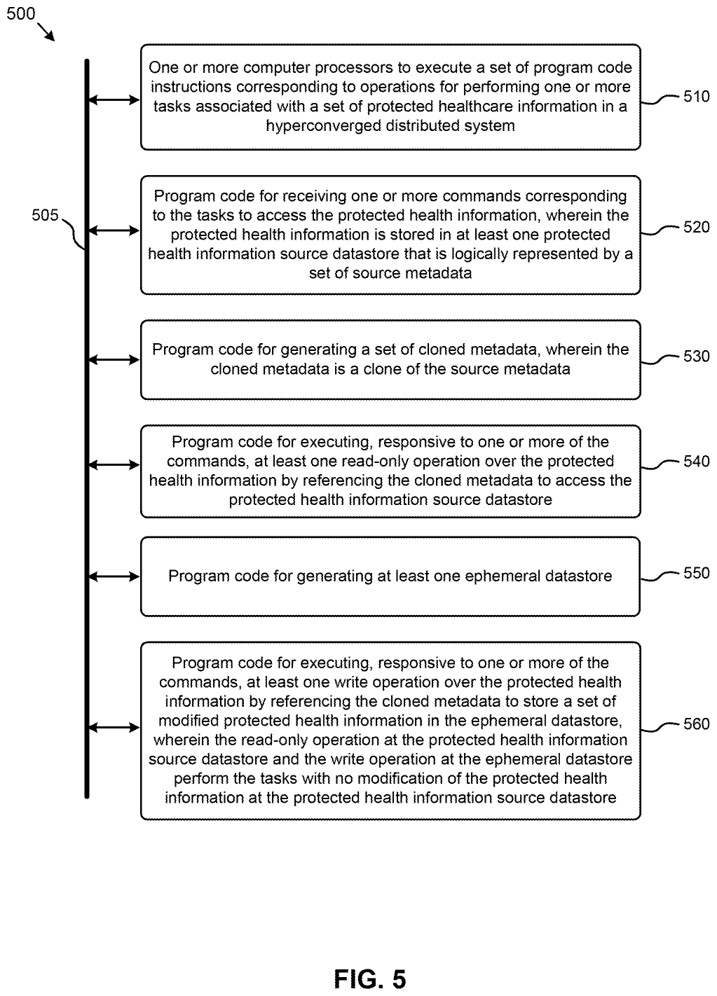

FIG. 5 depicts a system 500 as an arrangement of computing modules that are interconnected so as to operate cooperatively to implement certain of the herein-disclosed embodiments. This and other embodiments present particular arrangements of elements that individually, and/or as combined, serve to form improved technological processes that address maintaining regulatory compliance of protected health information accessed for various tasks in a hyperconverged distributed system. The partitioning of system 500 is merely illustrative and other partitions are possible. As an option, the system 500 may be implemented in the context of the architecture and functionality of the embodiments described herein. Of course, however, the system 500 or any operation therein may be carried out in any desired environment.

The system 500 comprises at least one processor and at least one memory, the memory serving to store program instructions corresponding to operations for performing one or more tasks associated with a set of protected healthcare information in a hyperconverged distributed system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims.

The shown embodiment implements a portion of a computer system, presented as system 500, comprising one or more computer processors to execute a set of program code instructions (module 510), and modules for accessing memory to hold program code instructions to perform: receiving one or more commands corresponding to the tasks to access the protected health information, wherein the protected health information is stored in at least one protected health information source datastore that is logically represented by a set of source metadata (module 520); generating a set of cloned metadata, wherein the cloned metadata is a clone of the source metadata (module 530); executing, responsive to one or more of the commands, at least one read-only operation over the protected health information by referencing the cloned metadata to access the protected health information source datastore (module 540); generating at least one ephemeral datastore (module 550); and executing, responsive to one or more of the commands, at least one write operation over the protected health information by referencing the cloned metadata to store a set of modified protected health information in the ephemeral datastore, wherein the read-only operation at the protected health information source datastore and the write operation at the ephemeral datastore perform the tasks with no modification of the protected health information at the protected health information source datastore (module 560).

Variations of the foregoing may include more or fewer of the shown modules. Certain variations may perform more or fewer (or different) steps, and/or certain variations may use data elements in more, or in fewer (or different) operations.

### System Architecture Overview

### Additional System Architecture Examples

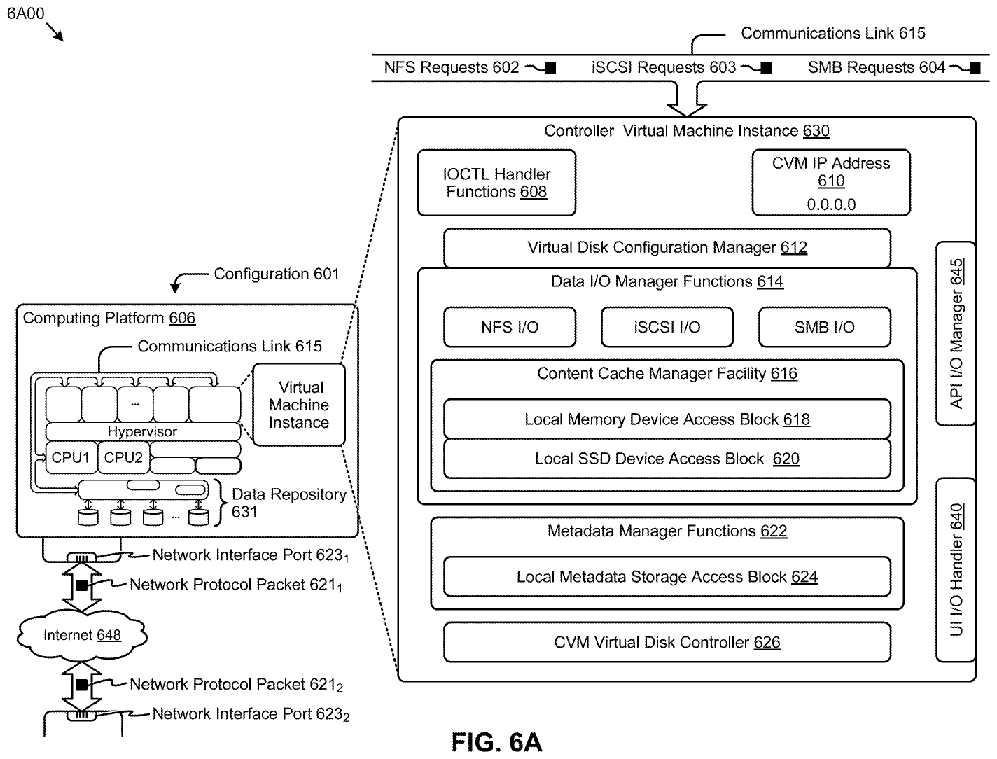

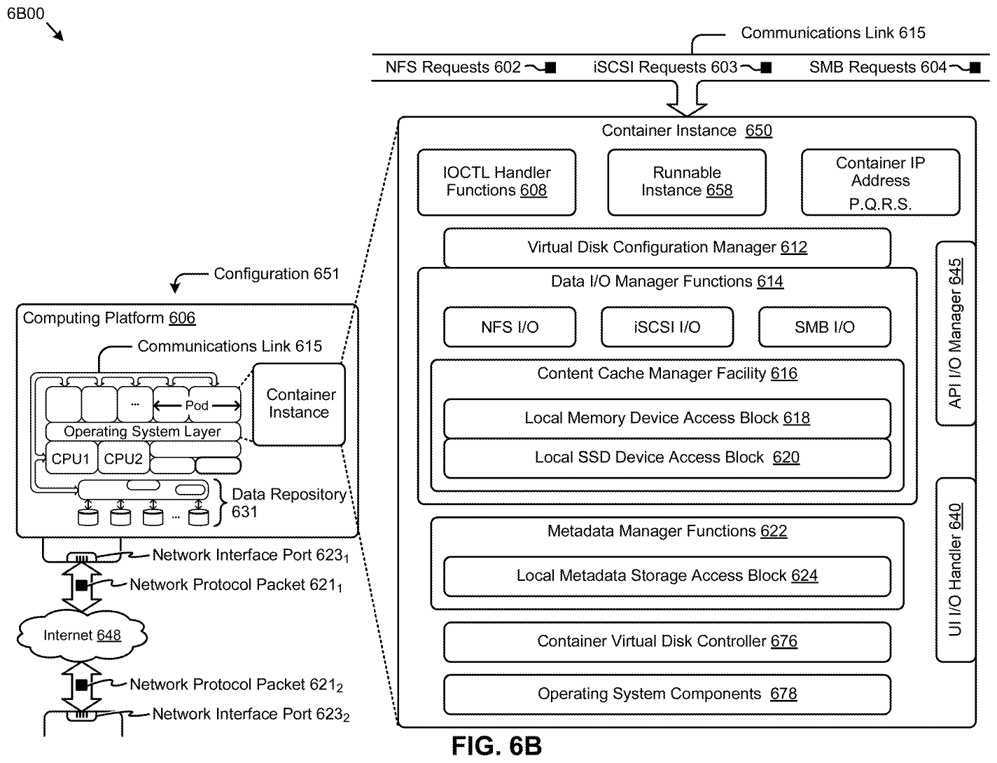

FIG. 6A depicts a virtualized controller as implemented by the shown virtual machine architecture 6A00. The heretofore-disclosed embodiments including variations of any virtualized controllers can be implemented in distributed systems where a plurality of networked-connected devices communicate and coordinate actions using inter-component messaging. Distributed systems are systems of interconnected components that are designed for or dedicated to storage operations as well as being designed for, or dedicated to, computing and/or networking operations. Interconnected components in a distributed system can operate cooperatively so as to serve a particular objective, such as to provide high-performance computing, high-performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates efficient use of compute and storage resources by and between the components of the distributed system. Adding a hyperconverged unit to a hyperconverged system expands the system in multiple dimensions. As an example, adding a hyperconverged unit to a hyperconverged system can expand in the dimension of storage capacity while concurrently expanding in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as containers. In some systems and/or environments, hypervisor-assisted virtualization techniques and operating system virtualization techniques are combined.

As shown, the virtual machine architecture 6A00 comprises a collection of interconnected components suitable for implementing embodiments of the present disclosure and/or for use in the herein-described environments. Moreover, the shown virtual machine architecture 6A00 includes a virtual machine instance in a configuration 601 that is further described as pertaining to the controller virtual machine instance 630. A controller virtual machine instance receives block I/O (input/output or JO) storage requests as network file system (NFS) requests in the form of NFS requests 602, and/or internet small computer storage interface (iSCSI) block JO requests in the form of iSCSI requests 603, and/or Samba file system (SMB) requests in the form of SMB requests 604. The controller virtual machine (CVM) instance publishes and responds to an internet protocol (IP) address (e.g., CVM IP address 610). Various forms of input and output (I/O or JO) can be handled by one or more JO control handler functions (e.g., IOCTL functions 608) that interface to other functions such as data JO manager functions 614 and/or metadata manager functions 622. As shown, the data JO manager functions can include communication with a virtual disk configuration manager 612 and/or can include direct or indirect communication with any of various block JO functions (e.g., NFS JO, iSCSI JO, SMB JO, etc.).

In addition to block JO functions, the configuration 601 supports JO of any form (e.g., block JO, streaming JO, packet-based JO, HTTP traffic, etc.) through either or both of a user interface (UI) handler such as UI JO handler 640 and/or through any of a range of application programming interfaces (APIs), possibly through the shown API JO manager 645.

The communications link 615 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 630 includes a content cache manager facility 616 that accesses storage locations, possibly including local dynamic random access memory (DRAM) (e.g., through the local memory device access block 618) and/or possibly including accesses to local solid state storage (e.g., through local SSD device access block 620).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 631, which in turn can be formatted into any one or more storage areas, and which can comprise parameterized storage accessible by a key (e.g., a filename, a table name, a block address, an offset address, etc.). An external data repository 631 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 624. The external data repository 631 can be configured using a CVM virtual disk controller 626, which can in turn manage any number or any configuration of virtual disks.

Execution of the sequences of instructions to practice certain embodiments of the disclosure are performed by a one or more instances of a software instruction processor, or a processing element such as a data processor, or such as a central processing unit (e.g., CPU1, CPU2). According to certain embodiments of the disclosure, two or more instances of a configuration 601 can be coupled by a communications link 615 (e.g., backplane, LAN, PTSN, wired or wireless network, etc.) and each instance may perform respective portions of sequences of instructions as may be required to practice embodiments of the disclosure.

The shown computing platform 606 is interconnected to the Internet 648 through one or more network interface ports (e.g., network interface port 6231 and network interface port 6232). The configuration 601 can be addressed through one or more network interface ports using an IP address. Any operational element within computing platform 606 can perform sending and receiving operations using any of a range of network protocols, possibly including network protocols that send and receive packets (e.g., network protocol packet 6211 and network protocol packet 6212).

The computing platform 606 may transmit and receive messages that can be composed of configuration data, and/or any other forms of data and/or instructions organized into a data structure (e.g., communications packets). In some cases, the data structure includes program code instructions (e.g., application code) communicated through the Internet 648 and/or through any one or more instances of communications link 615. Received program code may be processed and/or executed by a CPU as it is received and/or program code may be stored in any volatile or non-volatile storage for later execution. Program code can be transmitted via an upload (e.g., an upload from an access device over the Internet 648 to computing platform 606). Further, program code and/or results of executing program code can be delivered to a particular user via a download (e.g., a download from the computing platform 606 over the Internet 648 to an access device).

The configuration 601 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A cluster is often embodied as a collection of computing nodes that can communicate between each other through a local area network (e.g., LAN or VLAN) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provision of power to the other units. In some cases, a unit in a rack is dedicated to environmental conditioning functions such as filtering and movement of air through the rack, and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to implement algorithms that facilitate operational and/or performance characteristics pertaining to managing protected health information in distributed computing systems. In some embodiments, a module may include one or more state machines and/or combinational logic used to implement or facilitate the operational and/or performance characteristics pertaining to managing protected health information in distributed computing systems.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of managing protected health information in hyperconverged distributed computing systems). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to protected health information in hyperconverged distributed computing systems, and/or for improving the way data is manipulated when performing computerized operations pertaining to generating an ephemeral datastore and/or a clone of metadata associated with a protected health information (PHI) source datastore.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013 which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 6B depicts a virtualized controller implemented by a containerized architecture 6B00. The containerized architecture comprises a collection of interconnected components suitable for implementing embodiments of the present disclosure and/or for use in the herein-described environments. Moreover, the shown containerized architecture 6B00 includes a container instance in a configuration 651 that is further described as pertaining to the container instance 650. The configuration 651 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any container (e.g., container instance 650). A container instance can be executed by a processor. Runnable portions of a container instance sometimes derive from a container image, which in turn might include all, or portions of any of, a Java archive repository (JAR) and/or its contents, and/or a script or scripts and/or a directory of scripts, and/or a virtual machine configuration, and may include any dependencies therefrom. In some cases a configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container instance (e.g., a Docker container) can serve as an instance of an application container. Any container of any sort can be rooted in a directory system, and can be configured to be accessed by file system commands (e.g., “ls” or “ls-a”, etc.). The container might optionally include operating system components 678, however such a separate set of operating system components need not be provided. As an alternative, a container can include a runnable instance 658, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 676. Such a container virtual disk controller can perform any of the functions that the aforementioned CVM virtual disk controller 626 can perform, yet such a container virtual disk controller does not rely on a hypervisor or any particular operating system so as to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
receiving a task for managing access to protected health information (PHI) that only allows read-only access, wherein
the PHI is stored in a source datastore and is logically represented by metadata stored in and accessible by a hyperconverged system, and
the task includes a read-only operation and a write operation that modifies the PHI; and
executing the task to manage the access to the PHI at least by:
cloning the metadata into cloned metadata accessible by the hyperconverged system;
executing the write operation that modifies the PHI into modified PHI, with no modification to the PHI in the source datastore, at least by referencing the cloned metadata and by storing the modified PHI in an ephemeral datastore in the hyperconverged system; and
executing the read-only operation to read the PHI from the source data store at least by referencing the metadata.

2. The method of claim 1, wherein at least one of the cloned metadata or the ephemeral datastore is constructed based at least in part on a protection domain rule.

3. The method of claim 2, wherein the protection domain rule corresponds to a protection domain comprising the protected health information, and resources not included in the protection domain are not permitted to perform operations related to the PHI.

4. The method of claim 3, wherein the protection domain further comprises a node, a virtualized entity, a datastore, or a software application.

5. The method of claim 1, further comprising scheduling a task of generating the cloned metadata or a task of generating the ephemeral datastore that is not saved to a persistent storage location.

6. The method of claim 1, further comprising modifying, responsive to the write operation, the cloned metadata to point to a location in the ephemeral datastore storing the modified PHI in the hyperconverged system.

7. The method of claim 1, further comprising deleting the cloned metadata from the hyperconverged system.

8. The method of claim 1, further comprising deleting the ephemeral datastore from the hyperconverged system.

9. The method of claim 1, wherein the task comprises an application development task, an application testing task, or an application training task.

10. The method of claim 1, wherein the metadata or the cloned metadata comprise a logical file comprising a virtual disk, or a block map that maps a data block of the logical file to a physical data block in the source datastore.

11. A non-transitory computer readable medium having stored thereon a sequence of instructions which, when stored in memory and executed by a processor, causes the processor to perform a set of acts, the set of acts comprising:
receiving a task for managing access to protected health information (PHI) that only allows read-only access, wherein
the PHI is stored in a source datastore and is logically represented by metadata stored in and accessible by a hyperconverged system, and
the task includes a read-only operation and a write operation that modifies the PHI; and
executing the task to manage the access to the PHI at least by:
cloning the metadata into cloned metadata accessible by the hyperconverged system;
executing the write operation that modifies the PHI into modified PHI, with no modification to the PHI in the source datastore, at least by referencing the cloned metadata and by storing the modified PHI in an ephemeral datastore in the hyperconverged system; and
executing the read-only operation to read the PHI from the source data store at least by referencing the metadata.

12. The non-transitory computer readable medium of claim 11, wherein the cloned metadata or the ephemeral datastore is constructed based at least in part a protection domain rule.

13. The non-transitory computer readable medium of claim 12, wherein the protection domain rule corresponds to a protection domain comprising the protected health information.

14. The non-transitory computer readable medium of claim 13, wherein the protection domain further comprises a node, a virtualized entity, a datastore, or a software application.

15. The non-transitory computer readable medium of claim 11, the set of acts further comprising scheduling a task of generating the cloned metadata or a task of generating the ephemeral datastore that is not saved to a persistent storage location.

16. The non-transitory computer readable medium of claim 11, further comprising instructions which, when stored in the memory and executed by the processor, causes the processor to perform acts of modifying, responsive to the write operation, the cloned metadata to point to a location in the ephemeral datastore storing the modified PHI in the hyperconverged system.

17. The non-transitory computer readable medium of claim 11, further comprising instructions which, when stored in the memory and executed by the processor, causes the processor to delete the cloned metadata from the hyperconverged system.

18. The non-transitory computer readable medium of claim 11, further comprising instructions which, when stored in the memory and executed by the processor, causes the processor to delete the ephemeral datastore from the hyperconverged system.

19. A system for performing one or more tasks associated with a set of protected healthcare information in a distributed computing system, the system comprising:
a storage medium having stored thereon a sequence of instructions; and
one or more processors that execute the instructions to cause the one or more processors to perform a set of acts, the set of acts comprising,
receiving a task for managing access to protected health information (PHI) that only allows read-only access, wherein
the PHI is stored in a source datastore and is logically represented by metadata stored in and accessible by a hyperconverged system, and
the task includes a read-only operation and a write operation that modifies the PHI; and
executing the task to manage the access to the PHI at least by:
cloning the metadata into cloned metadata accessible by the hyperconverged system;
executing the write operation that modifies the PHI into modified PHI, with no modification to the PHI in the source datastore, at least by referencing the cloned metadata and by storing the modified PHI in an ephemeral datastore in the hyperconverged system;
executing the read-only operation to read the PHI from the source data store at least by referencing the metadata.

20. The system of claim 19, wherein at least one of the cloned metadata or the ephemeral datastore is constructed based at least in part on a protection domain rule.
